(19) United States
(12) Patent Application Publication
(10) Pub. No.: US 2007/0174388 A1
(43) Pub. Date: Jul. 26, 2007

(54) Integrated voice mail and email system

(76) Inventor: Michael Glenn Williams, Newbury Park, CA (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/336,611

(22) Filed: Jan. 20, 2006

(51) Int. Cl. G06F 15/16

(52) U.S. Cl. 709/204

(57) ABSTRACT

A method for managing text messages, includes transcript of voice mail media mail (voice mail or text message) messages. The media mail messages can be stored in a client device or a media mail server. A media mail message is a text-based message or a text transcription of at least part of an audio segment comprising a voice message or a conversation. The method comprising the steps of receiving an audio signal input from a user, the audio signal input including a command indicating a task, and performing the task according to the command. The tasks include: copying, deleting, replying, forwarding a message or saving a message to a folder, creating a new folder in the client device or in the media mail server, renaming, moving or deleting a folder in the client device or in the media mail server, searching for a term in a media mail message, and searching for a media mail message containing a keyword.

### TECHNICAL FIELD

The present invention pertains to systems that provide capabilities for sending and receiving messages electronically over a communication network. Particularly, the present invention relates to systems that enable integrating voice mail and electronic mail into one access method and provide tools for searching and organizing both types of mail messages.

### BACKGROUND ART

Voice mail (abbreviated as vmail hereinafter) is an interactive computerized system. A vmail system has functions of an answering machine, plus capabilities such as forwarding messages to another voice mailbox, sending messages to multiple voice mailboxes simultaneously, adding voice notes to a message, storing messages for future delivery, making calls to a telephone or paging service when a message is received, transferring callers to another phone for personal assistance, and playing different message greetings to different callers.

It is, however, difficult for a vmail user to browse, search and archive vmail messages. Normally, to retrieve information from an archived vmail message, a user has to dial a vmail server and listen to all archived messages sequentially in order to find the targeted one. Even if a message is found, extracting information in the message, such as caller's name, address, telephone number, etc. often involves playing the message repeatedly.

On the other hand, electronic mail (abbreviated as email hereinafter) and other text-based message services provide the same instantaneous connection as that of the vmail. Information transmitted by email is usually displayed and read on a properly equipped text terminal. An email system provides convenient tools for a user to index, manage and search email messages. Because of the benefits of memorializing communications in text form, storing messages indefinitely and managing messages easily, email is widely used as a non-verbal communication method.

Email and vmail are two separate systems for communication. Separate access methods and storage facilities are needed for the two types of communications. Emails can be accessed via a Web interface. Vmails normally can only be accessed by phones.

Therefore, it would be desirable to combine the features and advantages of vmail and email—i.e. the ease of using a telephone anywhere, the convenience of reading messages in text form and the flexibility of storing and managing messages for future reference. In other words, it would be advantageous if vmail messages could be accessed as quickly and easily as email messages.

In order to combine the features of email and vmail, i.e. merge an email system into a vmail system or vice versa, text-to-audio transformation methods, namely Speech to Text (STT) and Text to Speech (TTS) translations/convensions, are necessary. While TTS is a relatively straightforward transformation, STT, which involves human voice recognition, is not. There are two kinds of voice recognition, one is speaker-dependent voice recognition and the speaker-independent voice recognition. Speaker-dependent voice recognition is trained to the speech patterns of individual speakers. An example of speaker-dependent personal voice recognition tool is ViaVoice by IBM. Speaker-independent STT recognition recognizes speech from any speaker without previous training, but it usually has limited scalability and limited grammar.

Use of STT or TTS in combination with vmail or email, respectively, has been explored previously. Commercial services capable of reading emails aloud via a voice synthesizer are already available, which permit audio-based access to email messages. A prior art vmail handling software, SCANmail by AT&T, is capable of displaying vmail messages in the same format as email messages on an email browser. SCANmail automatically generates a transcript of a vmail message so a user can search vmail messages for content by text commands. Although these systems and methods are separately usable, they do not have the capabilities of integrating vmail and email messages in one facility and providing a unified method to access both types of messages. Individually, each of them has limited features.

Therefore, what is needed is an integrated vmail-email system. Such a system is referred to hereinafter as a media mail system. The media mail system must be capable of transmitting, receiving, storing, displaying and managing both types of messages. Users of the media mail system should be able to access vmail and email messages handled by the system by voice commands as well as text commands.

### SUMMARY OF THE INVENTION

In a first aspect of the invention, a method for managing media mail messages through a media mail browser is provided. The media mail messages are stored in a client device or a media mail server. A media mail message is a text-based message or a text transcription of at least part of an audio segment comprising a voice message or a conversation. The method comprises the steps of receiving an audio signal input from a user, the audio signal input including a command indicating a task to be performed by the media mail browser, and performing the task according to the command.

Examples of such a task include:
copying, deleting, replying or forwarding a media mail message according to a respective command;
creating a new folder according to a respective command and a name of the folder spoken by the user;
renaming, moving or deleting a folder according to a respective command and a name of the folder spoken by the user;
searching for a term in a media mail message in response to a respective command and the term spoken by the user; and
searching for a media mail message containing a keyword in a folder in response to a respective command and the keyword spoken by the user.

In the method, the step of receiving the audio signal input from the user comprises processing the audio signal input to obtain the command based on speech patterns of the user.

In a second aspect of the invention, a method is provided, comprising the steps of generating a text transcription based on at least part of an audio segment, the audio segment comprising a voice message or a conversation involving a user, and transmitting the text transcription and the audio segment as messages receivable by one or more remote devices. In the method, the text transcription is generated based on speech patterns of the user.

In a third aspect of the invention, a system for managing media mail messages through a media mail browser is provided. The media mail messages are stored in a client device or a media mail server. A media mail message is a text-based message or a text transcription of at least part of an audio segment comprising a voice message or a conversation. The system comprises means for receiving an audio signal input from a user, the audio signal input including a command indicating a task to be performed by the media mail browser, and means for performing the task according to the command. In the system, the means for receiving the audio signal input from the user comprises means for processing the audio signal input to obtain the command based on speech patterns of the user.

In a fourth aspect of the invention, a system is provided, comprising a media processor, the media processor comprising means for generating a text transcription based on at least part of an audio segment, and means for transmitting the text transcription and the audio segment as messages receivable by one or more remote devices. The audio segment comprises a voice message or a conversation involving a user. In the method, the means for generating a text transcription comprises means for generating a text transcription based on speech patterns of the user.

The system may further comprise means for receiving a text transcription based on at least part of an audio segment, the audio segment comprising a voice message or a conversation involving a remote user, and means for storing the audio segment and the text transcription involving the remote user as messages.

The media processor of the system may further comprise means for generating an audio presentation of a text message.

The system may further comprise means for receiving the user's input in audio or text format, and means for playing audio segments comprising voice messages or conversations, or displaying text transcriptions based on at least part of the audio segments. The audio segments or the text transcriptions may involve the same or different users.

In a fifth aspect of the invention, a server is provided, comprising a media processor, the media processor comprising means for generating a text transcription based on at least part of an audio segment, and means for transmitting the text transcription and the audio segment as messages receivable by one or more remote devices. The audio segment comprises a voice message or a conversation involving a user.

The server may further comprise means for receiving a text transcription based on at least part of an audio segment, the audio segment comprising a voice message or a conversation involving a remote user, and means for storing the audio segment and the text transcription involving the remote user as messages. In the server, the means for generating a text transcription may comprise means for generating a text transcription based on speech patterns of the user.

The media processor of the server may further comprise means for generating an audio presentation of a text message.

In the server, the storage means comprises a plurality of media mailboxes and a mailbox accessible by a client device of a user.

In a sixth aspect of the invention, a device is provided, comprising means for generating a text transcription based on at least part of an audio segment, the audio segment comprising a voice message or a conversation involving a user, and means for transmitting the text transcription and the audio segment as messages receivable by one or more remote devices.

The device may further comprise means for receiving the user's input in audio or text format, and means for playing audio segments comprising voice messages or conversations, or displaying text transcriptions based on at least part of the audio segments. The audio segments or the text transcriptions may involve the same or different users.

In the device, the means for generating a text transcription of the device may comprise means for generating a text transcription based on speech patterns of the user.

Further, the device may be a wireless communication device and the means for transmitting the text transcription and the audio segment as messages may comprise means for transmitting the messages to a media mail server in a wireless network.

In a seventh aspect of the invention, a computer program product is provided, comprising a computer readable storage structure embodying a computer program code, the code comprising instructions for generating a text transcription based on at least part of an audio segment, the audio segment comprising a voice message or a conversation involving a user, and instructions for transmitting the text transcription and said audio segment as messages receivable by one or more remote devices.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram illustrating one example of electronic communications via integrated media mail systems;

FIG. 2 is a block diagram illustrating another example of electronic communications via integrated media mail systems;

FIG. 3 is a block diagram of a media mail system according to the invention;

FIG. 4 is a block diagram of a media processor according to the invention;

FIG. 5 is an alternative block diagram of a media mail system according to the invention; and

FIG. 6 is a block diagram illustrating a plurality of users accessing a media mail server according to the invention.

### DETAILED DESCRIPTION OF THE INVENTION

Throughout this application, the term “audio” refers to any representation or encoding of audio signal segments, in any standard digital, analog or proprietary format. The audio might be a part of combined audio-video signals. The term “text message” or “text” refers to any representation or encoding of text-based communication including file attachments that may be in any format including audio or video.

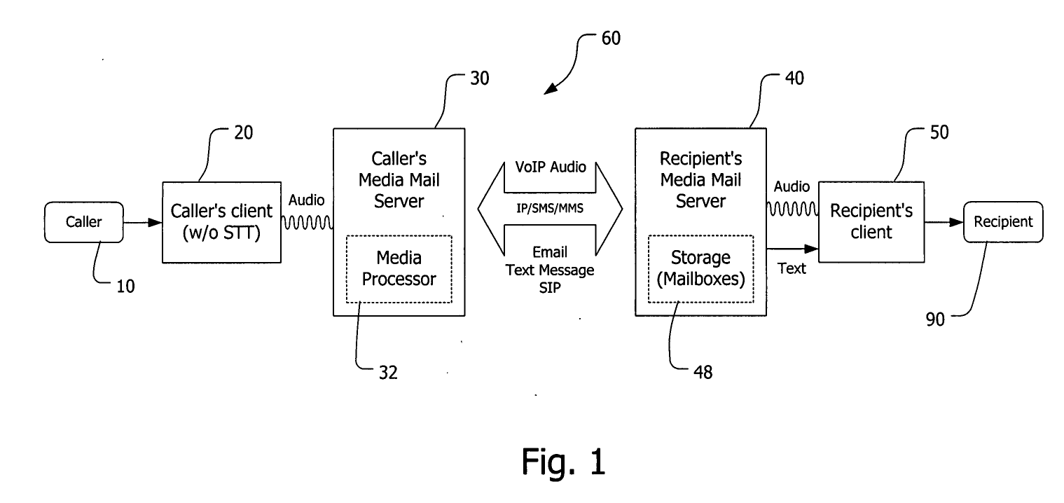

Integrated Media Mail Communication System Communication via integrated media email systems according to the invention is shown in FIG. 1. A caller 10 makes a phone call or leaves a vmail message using a client device 20, such as a mobile phone. The client device 20 is connected to a network 60 comprising a media mail server 30. Assuming that the client device 20 does not have a speaker-trained STT engine (application software), the call is directed to a media processor 32 in the media mail server 30. In the media processor 32, the voice signals are transformed into VoIP (Voice over Internet Protocol) signals or other digital formats that can be transmitted through the network 60. The media processor 32 is equipped with a speaker-trained STT engine. A text transcript of the voice signals, or at least a part of the voice signals, is generated by the speaker-trained STT engine. The text transcript is saved in the form of a text file or a control message (e.g. an email message, a SMS (short message service) message, or a SIP (session initiation protocol) signal string). Both the voice signals and the transcript of the voice signals are transmitted to the recipient 90 using communication network enabled mechanisms such as VoIP and/or asynchronous messaging such as SMS or MMS (multimedia messaging service).

If a recipient 90 of the call is able to connect to the network 60 through an integrated media mail server 40 comprising a media mail storage 48, the voice signals and the text transcription of the voice signals are received by the server 40 and stored together in the recipient's media mailbox in the media mail storage 48 for retrieval. The recipient accesses the media mail messages—in voice format, text format or both—through one or more client devices 50.

If the recipient's connection to the network is not through an integrated media mail server, the vmail message and an email message comprising text transcription of the vmail message is likely stored separately in the recipient's vmail server and email server, respectively (not shown in FIG. 1). The recipient accesses the media mail messages separately through one or more client devices 50.

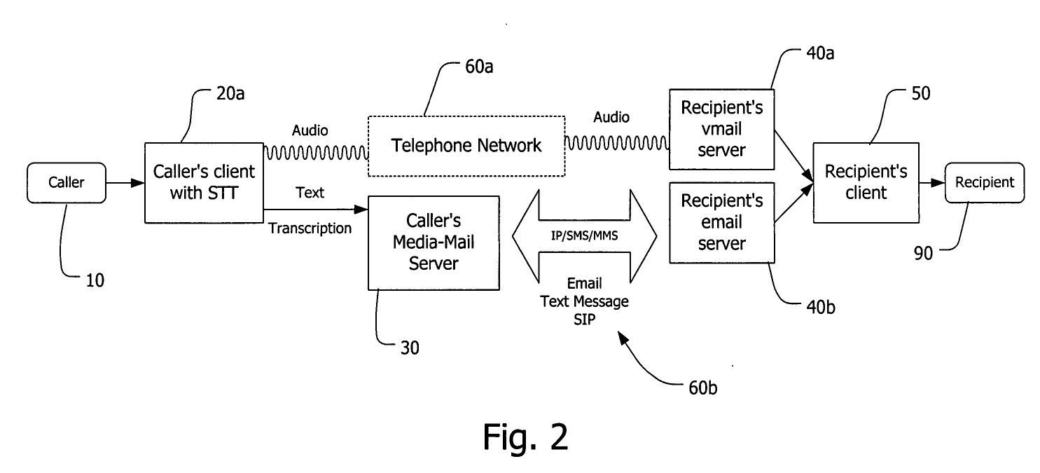

This scenario can have numerous alternatives. For example in FIG. 2, if the client device 20a is equipped with a speaker-trained STT engine, it can automatically generate a text transcript of a phone call. The phone call can be a live conversation with a recipient, or a vmail message. The voice signals of the caller may be transmitted by the client device 20a, through a public switched telephone network 60a, or another network capable of transmitting Internet packets, to the recipient's handset 50 or recipient's vmail server 40a. The text transcript generated during the phone call is transmitted to the caller's media mail server 30, where it is transmitted, via a communication network 60b, to the recipient's email server 40b.

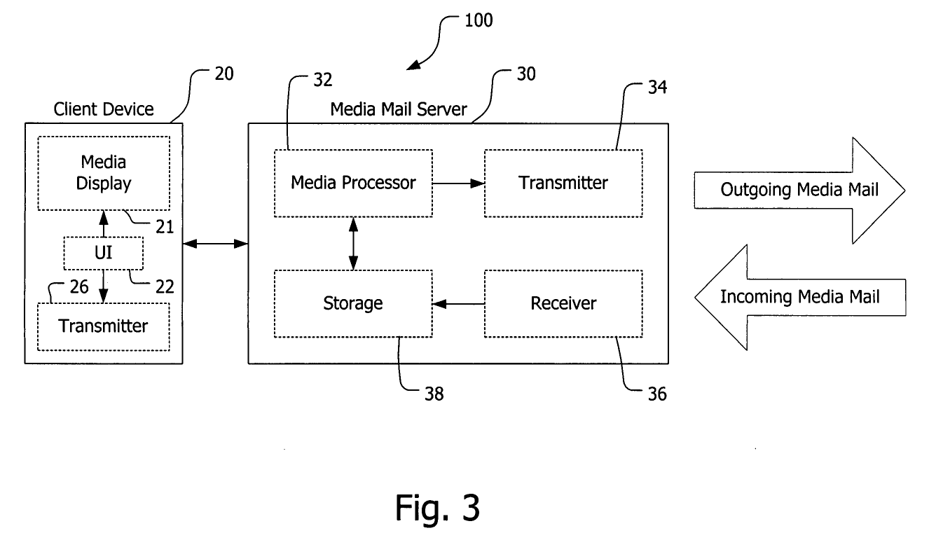

As shown in FIG. 3, an integrated media mail system 100 transmits, receives, stores, displays and manages media mail messages in a unified manner. The system includes a media mail server 30 and one or more client device 20.

In one example, the media mail server 30 includes a media processor 32, a transmitter 34, a receiver 36 and a media mail storage 38 comprising users' media mail boxes. The transmitter 34 is capable of transmitting an audio message and a text transcription of at least a part of the audio message to a remote device through a network. The transmitter 34 is also capable of transmitting an ordinary text message, such as an email message, to the remote device through the network. The receiver 36 is capable of receiving an audio message and a text transcription of at least a part of the audio message from a remote device through the network. The receiver 36 is also capable of receiving an ordinary text message, such as an email message, from a remote device through the network. The media mail storage 38 stores audio messages, text transcriptions of the audio messages, and text-based messages.

The client device 20 comprises a user interface means 22 for inputting text or audio signals, a media display means for displaying audio signals of an audio message or text of a transcription of the audio message. If the client device is a wireless device, it also comprises a transmitter 26 for transmitting text or audio signals to the server 30.

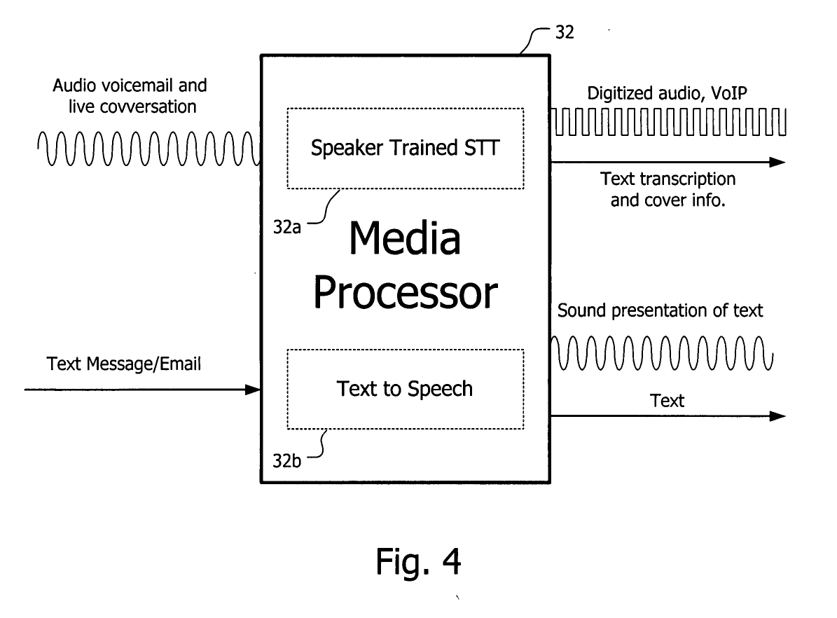

The media processor 32 as shown in FIG. 3 is further shown in FIG. 4. The media processor 32 is capable of producing a text transcription of an audio segment such as a vmail message or a live conversation. In addition, the media processor is capable of accepting an audio command from the client device, and transforming the audio command into an instruction. Such instruction is for managing media mail messages in the media mail storage. Further, the media processor is capable of producing an audio presentation of at least a part of a text message. The audio presentation of the text message is sent to the media display means of the client device, which plays the text message in a synthesized voice.

In order to perform the above functions, the media processor 32 is preferably equipped with a STT engine 32a and a TTS engine 32b. Further, the STT engine 32a is preferably speaker-trained to each registered user's voice patterns. For anonymous or guest users of the system, a speaker-independent STT engine is used.

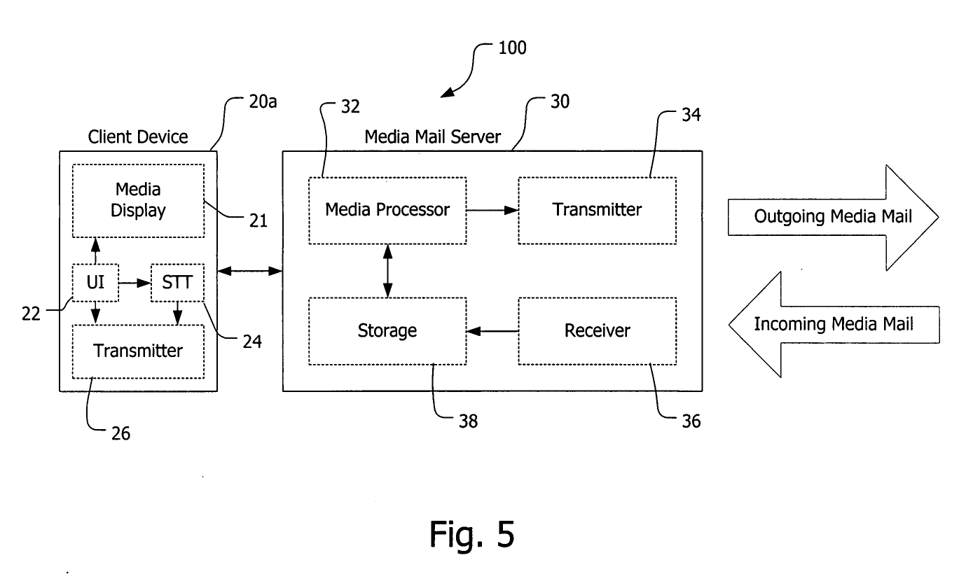

Referring now to FIG. 5, if a client device 20a in a media mail system is a mobile device that has a speaker-trained STT engine 24, it performs the transcription function of the media processor 32. Audio signals, and a text transcription, of a call are transmitted to the media mail server for further processing or forwarding to a remote device.

Further, the STT engine in the media processor 32 or the STT engine 24 in the client 10 device 20a is capable of transcribing a real-time conversation or at least the part of the conversation that is the caller's speech. Once an audio or audio-visual call begins, the STT engine starts to generate a transcription of the call based on the signals from caller's voice channel (for example, voice signals from caller's microphone). The transcription is saved at the end of the call. A signal may be generated either during or at the end of the call, indicating that a transcription of the call will be forwarded to the recipient. (The recipient's email or media mail address must be known to the caller in order to forward the transcription to the email or media mail box.) The signal could be an audio signal such as a tone, a SIP message, or other forms of data or control messages.

The recipient accepting a transcription of a vmail message can either directly receive it on a mobile phone that accepts text messages, or receive it by accessing recipient's media mail or email servers.

Managing Media Mail Messages

A user may access the media mail messages stored either in the user's client device or in the media mail storage of the media mail server through the user interface of the client device. In one example, the client device comprises a web browser that accepts audio input in addition to text menu-based commands in navigating through the media mail files stored in the device for creating, renaming or rearranging folders, and moving, copying or deleting messages. In another example, the media mail server has an httpd (HyperText Transfer Protocol Daemon) that accepts audio and text input transmitted from the client device. The user may use text-based commands as well as voice-based commands to access the media mail messages stored in the media mail server. The voice command is converted into a text transcript or a command equivalent to a text command by the media processor.

Examples of media mail message management tasks include:
copying, deleting, replying, forwarding a message or saving a message to a folder in response to a respective command spoken by the user,
creating a new folder in the client device or in the media mail server in response to the name of the folder spoken by the user,
renaming, moving or deleting a folder in the client device or in the media mail server in response to a respective command spoken by the user,
searching for a term in a media mail message in response to the term spoken by the user, and
searching for a media mail message in the client device or in the media mail server containing a keyword in response to the keyword spoken by the user.

A media mail server normally has a plurality of users. The speaker-trained STT in the media mail server is capable of performing STT for each user according to their speech patterns. Users may use different client devices to access the media mail server in a number of different ways. The following example illustrates how the media mail system may be utilized.

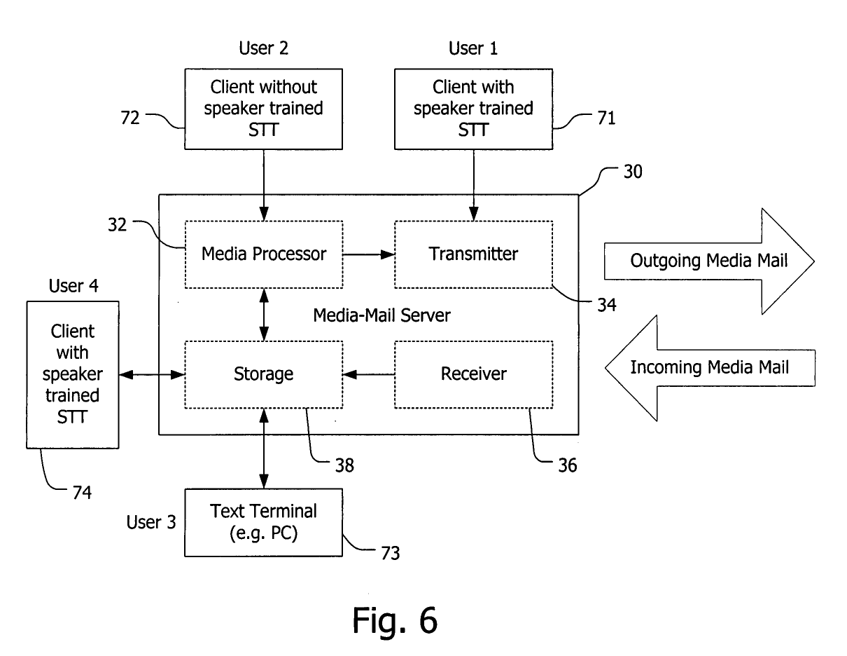

Referring now to FIG. 6, a first user (User 1) has a client device 71 that has the speaker trained STT capability. The user makes a phone call through the device and the device automatically transcribes the call and submits the voice call and the transcription to the media mail server 30 for transmitting to a remote server, from which the voice call and the transcription are forwarded to the recipient. A second user (User 2) has an ordinary mobile phone 72 that does not have the speaker-trained STT capability, and the call is routed to the media processor 32 in the media mail server 30. Through the processor 32 the call is transcribed and the voice signal and the transcription are forwarded (by the transmitter 34) as shown as outgoing media mail to the remote server. A third user (User 3) accesses the media mail server 30 via a text-based terminal 73 such as a personal computer (PC). The media mail messages, including transcriptions, are listed on the text terminal by a browser. The user can search the media mails by typing key words, and transcriptions of audio calls are displayed on the terminal like a text email. The user can manage media mails, such as copying, deleting, replying, forwarding, saving to subfolders, etc., by typing in text commands or using the browser menus. A fourth user (User 4) accesses the media mail server by a client device 74 capable of speaker-trained STT. This user can access and manage the media mail files by audio commands, and the device can translate the audio commands into text commands or equivalent.

In summary, the present invention provides a method that integrates vmail and email into one system. The method enables searching and organizing both types of mails by using one type of tools. Under such system, sending, receiving, filing and searching for both email and vmail are accomplished by using the same client device connecting to the same server.

The present invention has been disclosed in reference to specific examples therein. Numerous modifications and alternative arrangements may be devised by those skilled in the art without departing from the scope of the present invention, and the appended claims are intended to cover such modifications and arrangements.

1. A method for managing media mail messages, said media mail messages being stored in a client device or a media mail server, a media mail message being a text-based message or a text transcription of at least a part of an audio segment comprising a voice message or a conversation, said method comprising:
receiving an audio signal input from a user, said audio signal input including a command indicating a task in connection with a media mail message, and
performing the task according to the command.

2. The method according to claim 1, wherein the task is copying, deleting, replying or forwarding the media mail message according to a respective command.

3. The method according to claim 1, wherein the task is creating a new folder according to a respective command and a name of the folder spoken by the user.

4. The method according to claim 1, wherein the task is renaming, moving or deleting a folder according to a respective command and a name of the folder spoken by the user.

5. The method according to claim 1, wherein the task is searching for a term in a media mail message in response to a respective command and the term spoken by the user.

6. The method according to claim 1, wherein the task is searching for the media mail message containing a keyword in a folder in response to a respective command and the keyword spoken by the user.

7. The method according to claim 1, wherein receiving the audio signal input from the user comprises processing the audio signal input to obtain the command based on speech patterns of the user.

8. The method according to claim 1, wherein performing the task according to the command comprises using a media mail browser having an (HyperText Transfer Protocol Daemon) that accepts audio input from the client device.

9. A method, comprising:
generating a text transcription based on at least a part of an audio segment, said audio segment comprising a voice message or a conversation involving a user, and
transmitting said text transcription and said audio segment as messages receivable by one or more remote devices.

10. The method of claim 9, wherein the text transcription is generated based on speech patterns of the user.

11. A system for managing media mail messages, said media mail messages being stored in a client device or a media mail server, a media mail message being a text-based message or a text transcription of at least a part of an audio segment comprising a voice message or a conversation, the system comprising:
a user interface for receiving an audio signal input from a user, said audio signal input including a command indicating a task, and
a processor for performing the task according to the command.

12. The system according to claim 11, wherein the system further comprises a processor for processing the audio signal input to obtain the command based on speech patterns of the user.

13. A system, comprising:
a media processor, comprising means a unit for generating a text transcription based on at least a part of an audio segment, said audio segment comprising a voice message or a conversation involving a user, and
a transmitter for transmitting said text transcription and said audio segment as messages receivable by one or more remote devices.

14. The system of claim 13, further comprising:
a receiver for receiving a text transcription based on at least a part of an audio segment, said audio segment comprising a voice message or a conversation involving a remote user, and
a storage unit for storing said audio segment and said text transcription involving the remote user as messages.

15. The system of claim 13, wherein the a unit for generating a text transcription is configured to generate the text transcription based on speech patterns of the user.

16. The system of claim 13, wherein the media processor further comprises a unit for generating an audio presentation of a text message.

17. The system of claim 13, further comprising:
a user interface for receiving the user's input in audio or text format, and
a display unit for playing audio segments comprising voice messages or conversations, or displaying text transcriptions based on at least a part of the audio segments, said audio segments or said text transcriptions involving the same or different users.

18. A server, comprising:
a media processor, comprising a unit for generating a text transcription based on at least a part of an audio segment, said audio segment comprising a voice message or a conversation involving a user, and
a transmitter for transmitting said text transcription and said audio segment as messages receivable by one or more remote devices.

19. The server of claim 18, further comprising:
a receiver for receiving a text transcription based on at least a part of an audio segment, said audio segment comprising a voice message or a conversation involving a remote user, and
a storage unit for storing as messages said audio segment and said text transcription involving the remote user.

20. The server of claim 18, wherein the unit for generating a text transcription is configured to generate the text transcription based on speech patterns of the user.

21. The server of claim 18, wherein the media processor further comprises a unit for generating an audio presentation of a text message.

22. The server of claim 19, wherein the storage unit comprises a plurality of media mailboxes and a mailbox is accessible by a client device of a user.

23. A device, comprising:
a processor for generating a text transcription based on at least a part of an audio segment, said audio segment comprising a voice message or a conversation involving a user, and
a transmitter for transmitting said text transcription and said audio segment as messages receivable by one or more remote devices.

24. The device of claim 23, further comprising:
a receiver for receiving the user's input in audio or text format, and
a display unit for playing audio segments comprising voice messages or conversations, or displaying text transcriptions based on at least a part of the audio segments, said audio segments or said text transcriptions involving same or different users.

25. The device of claim 23, wherein the processor for generating a text transcription is configured to generate the text transcription based on speech patterns of the user.

26. The device of claim 23, wherein the device is a wireless communication device and the transmitter for transmitting the text transcription and the audio segment as messages is configured transmit said messages to a media mail server via a wireless communication network.

27. A computer program product, comprising a computer readable storage medium embodying computer program code thereon, wherein said computer program code comprises:
instructions for generating a text transcription based on at least part of an audio segment, said audio segment comprising a voice message or a conversation involving a user, and
instructions for transmitting said text transcription and said audio segment as messages receivable by one or more remote devices.

28. The computer program product of claim 27, wherein the instructions for generating a text transcription comprising instructions for generate the text transcription based on speech patterns of the user.

29. The system according to claim 11, wherein the task is copying, deleting, replying or forwarding the media mail message according to a respective command.

30. The system according to claim 11, wherein the task is creating a new folder according to a respective command and a name of the folder spoken by the user.

31. The system according to claim 11, wherein the task is renaming, moving or deleting a folder according to a respective command and a name of the folder spoken by the user.

32. The system according to claim 11, wherein the task is searching for a term in a media mail message in response to a respective command and the term spoken by the user.

33. The system according to claim 11, wherein the task is searching for the media mail message containing a keyword in a folder in response to a respective command and the keyword spoken by the user.

34. A system for managing media mail messages, said media mail messages being stored in a client device or a media mail server, a media mail message being a text-based message or a text transcription of at least a part of an audio segment comprising a voice message or a conversation, the system comprising:
means for receiving an audio signal input from a user, said audio signal input including a command indicating a task, and
means for performing the task according to the command.

35. The system according to claim 34, wherein the system further comprises means for processing the audio signal input to obtain the command based on speech patterns of the user.

36. A system, comprising:
means for generating a text transcription based on at least a part of an audio segment, said audio segment comprising a voice message or a conversation involving a user, and
means for transmitting said text transcription and said audio segment as messages receivable by one or more remote devices.

37. The system of claim 36, further comprising:
means for receiving a text transcription based on at least a part of an audio segment, said audio segment comprising a voice message or a conversation involving a remote user, and
means for storing said audio segment and said text transcription involving the remote user as messages.

38. The system of claim 36, wherein the means for generating a text transcription is configured to generate the text transcription based on speech patterns of the user.

39. The system of claim 36, further comprising means for generating an audio presentation of a text message.

40. The system of claim 36, further comprising:
means for receiving the user's input in audio or text format, and
means for playing audio segments comprising voice messages or conversations, or displaying text transcriptions based on at least a part of the audio segments, said audio segments or said text transcriptions involving the same or different users.

41. A server, comprising:
means for generating a text transcription based on at least a part of an audio segment, said audio segment comprising a voice message or a conversation involving a user, and
means for transmitting said text transcription and said audio segment as messages receivable by one or more remote devices.

42. The server of claim 41, further comprising:
means for receiving a text transcription based on at least a part of an audio segment, said audio segment comprising a voice message or a conversation involving a remote user, and
means for storing as messages said audio segment and said text transcription involving the remote user.

43. The server of claim 41, wherein the means for generating a text transcription is configured to generate the text transcription based on speech patterns of the user.

44. The server of claim 41, further comprising means for generating an audio presentation of a text message.

45. A device, comprising:
means for generating a text transcription based on at least a part of an audio segment, said audio segment comprising a voice message or a conversation involving a user, and
means for transmitting said text transcription and said audio segment as messages receivable by one or more remote devices.

46. The device of claim 45, further comprising:
means for receiving the user's input in audio or text format, and
means for playing audio segments comprising voice messages or conversations, or displaying text transcriptions based on at least a part of the audio segments, said audio segments or said text transcriptions involving same or different users.

47. The device of claim 45, wherein the means for generating a text transcription is configured to generate the text transcription based on speech patterns of the user.

48. The device of claim 45, wherein the device is a wireless communication device and the means for transmitting the text transcription and the audio segment as messages is configured to transmit said messages to a media mail server via a wireless communication network.
